(19) United States
(12) Patent Application Publication
(10) Pub. No.: US 2005/0110644 A1
(43) Pub. Date: May 26, 2005

(54) Enuresis device with magnetic fastener

(76) Inventors: Jeffrey Abramson, Los Gatos, CA (US); Robby Jay Moore, Auburn, CA (US)

Correspondence Address: Bruce H. Johnsonbaugh;Eckhoff & Hoppe, 333 Sacramento Street, San Francisco, CA, 94111, US

(21) Appl. No.: 10/950,795

(22) Filed: Sep. 27, 2004

Related U.S. Application Data
(60) Provisional application No. 60/523,864, filed on Nov. 20, 2003.

(51) Int. Cl. G08B 23/00

(52) U.S. Cl. 340/573.5; 24/303; 340/693.9

(57) ABSTRACT

A magnetic fastener and carrier is provided for use in an enuresis device wherein an alarm is carried by an upper undergarment worn by the user. The magnetic fastener and carrier preferably includes a first disc having a hollowed out recess and a second disc adapted to fit into the hollowed out recess. The two discs are magnetically coupled and are positioned on opposite surfaces of the upper undergarment.

### CROSS-REFERENCE TO RELATED APPLICATION

This application claims the benefit of and priority from U.S. provisional application Ser. No. 60/523,864 filed Nov. 20, 2003.

### BACKGROUND AND BRIEF SUMMARY OF INVENTION

The present invention relates generally to devices for treating enuresis. Typical prior art devices utilize a urine sensor carried on a user's underpants and an alarm carried on the user's pajama top, for example. The present invention relates to the mechanism for fastening or attaching the alarm to the pajama top (or other upper undergarment).

It has been known for many years that alarms that sound at the first moment of bed wetting are the most effective training devices available for the treatment of enuresis. While under the sheet alarms (pad and bell type) were once used, these early devices have gradually been replaced by some type of small alarm which is worn at night by the child. In most cases the alarm is worn near the child's ear, most often on the pajama top. It may also be worn on a lapel of a garment, but the shoulder areas have advantages by being left uncovered and open to allow maximum sound no matter what the child's position is during sleep. Typically a small diameter wire cord connects the shoulder-worn alarm with some type of urine sensor. Cotton underwear may be worn by the child and a clip attachment to the front of the underwear can be used as the urine sensor.

A problem presented in the design of shoulder-worn alarms is a convenient method of secure attachment of the device to the pajama top without inconvenience to the child or to the parent. A safety pin, such as a diaper-type pin, may be used as is seen in the device sold by Malem Medical of Nottingham, England. The Night Trainer made by Night Trainer Company of Portland, Oreg., uses multiple pins to hold two strips of loop VELCRO to the pajama top. A matching piece of hook VELCRO on the underside of the alarm then secures the box-like device to the shoulder area of the pajama. The WET-STOP Alarm of Palco Labs has for many years been furnished with multiple VELCRO strips which are punched with holes and sewn by a parent to several sets of pajama tops and underwear. Once secured by sewing, the VELCRO strips remain in place indefinitely and are not injured by laundering the pajamas or the undershorts.

While the alarm attachment methods mentioned are fairly successful, the methods described have some real disadvantages. Safety pins in some circumstances can become dislodged or opened and thereby possibly causing injury to the child. In general, the pins must be removed for laundering of the garments which requires extra time and effort on the part of the parent. Although VELCRO attachments are fairly secure, sewing the VELCRO patches or strips is time consuming and may present special difficulties for parents who are not familiar with sewing techniques. What is clearly needed is an improvement in the method of attachment for small devices worn on the child's pajamas. The present invention is such an improvement since it does not require the use of pins or any special efforts by the parents or caregiver. A method has been found to give comfortable and secure attachment which is easy to use and may be quickly applied by the child himself at bedtime. Because of the magnetic processes involved, the apparatus is of interest to children who may be unfamiliar with magnetic forces.

The present invention provides in one embodiment a magnetic fastener or attachment wherein a hollowed-out disc carrying a magnet and carrying the alarm is positioned on the outer surface of the upper undergarment. A smaller disc made of steel or other material attracted to the magnet is positioned on the inner surface of the upper undergarment adjacent the hollowed-out region of the outer disc. The two discs are magnetically coupled and form a fastener or attachment for connecting the alarm to the upper undergarment. No potentially dangerous safety pins are utilized. Parents are not required to sew VELCRO strips onto the undergarment. The attachment is extremely safe and secure.

A further aspect of the invention is that the two magnetically coupled discs may also be sized to be physically coupled. The smaller disc may be sized to snap into the hollowed-out recess of the larger disc, thereby physically clamping the discs onto the upper under garment.

The discs may be sized to allow a child to open and close the fastener easily and safely.

A primary object of the invention is to provide an enuresis device with a magnetically coupled fastener for removably attaching an alarm to the user's upper undergarment.

A further object is to provide an enuresis device with a fastener for the alarm which avoids the use of safety pins and/or VELCRO strips.

Another object is to provide an enuresis device with an alarm fastener that is easily opened or closed by a child.

Other objects and advantages of the invention will become apparent from the following detailed description and drawings wherein:

### BRIEF DESCRIPTION OF THE DRAWINGS

FIG. 1 shows a child wearing the magnetically attached device;

FIG. 2 shows a front view of the device attached to a pajama top;

FIG. 3 shows the back side of the device;

FIG. 4 is a side elevational view of the device on a pajama top held by the magnetic force between the two magnetically coupled discs;

FIG. 5 shows the magnetic fastener opened; and

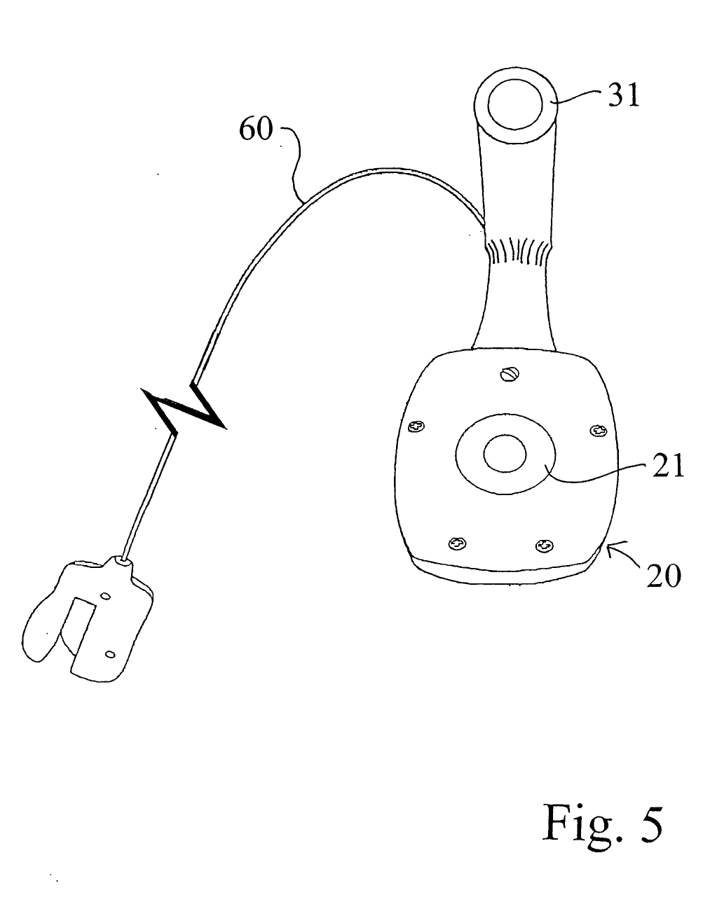

FIG. 6 shows the magnetic fastener closed.

### DETAILED DESCRIPTION OF THE DRAWINGS

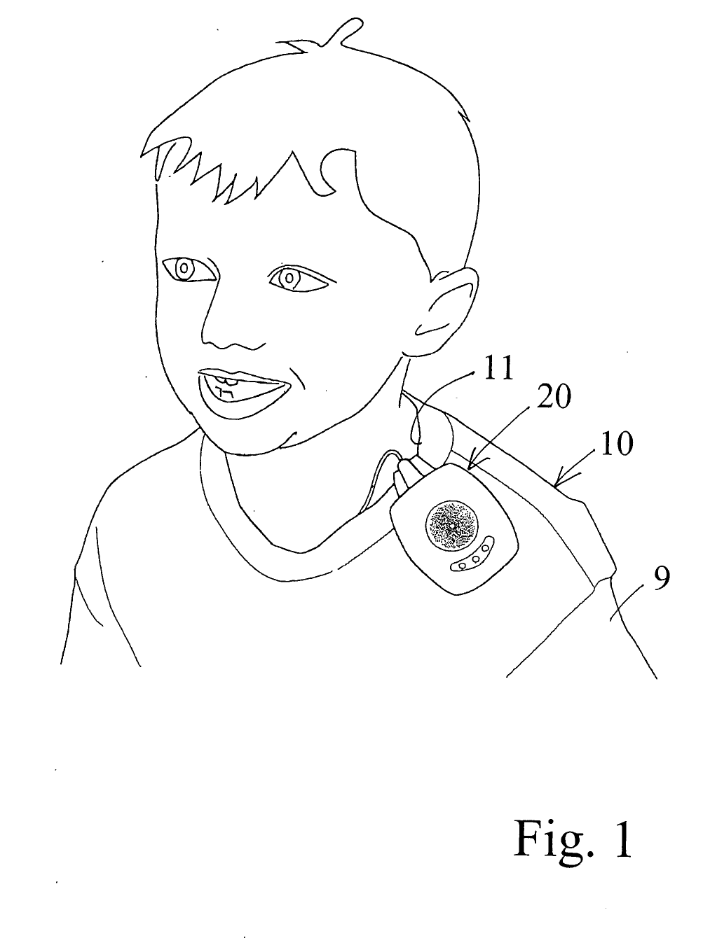

FIG. 1 of the drawings illustrates a child 9 wearing the magnetic fastener shown generally as 20. The magnetic fastener 20 of the present invention is shown as carried by the collar 11 of pajama top or other upper undergarment shown generally as 10 which covers at least part of the torso. The device 20 is carried as close as possible to the child's ear, provided the device can be worn comfortably by the child and not unduly interfere with his sleep.

As noted above, the device 20 carries an alarm which is connected by cable 60 to a urine sensor (not shown) which is carried on the front of the child's underpants or other lower undergarment covering the pubic area. A variety of urine sensors are available and the present invention is independent of the precise type of urine sensor utilized.

As shown and described herein, the device 20 is shown attached to the collar of a pajama top 10. As described herein and in the claims, the device may be attached to the upper undergarment 10 at other positions, provided that the device 20 can be worn comfortably and wherein the alarm carried by device 20 can be easily heard by the child. Other types of upper undergarments can be used in conjunction with the present invention. As described herein and in the claims, the invention is described in conjunction with a lower undergarment which carries the urine sensor. The phrase “lower undergarment” is to be construed broadly to include underpants, pajama bottoms, sweat pants and the like. Similarly, as used herein and in the claims, the term “upper undergarment” is to be construed broadly to include T-shirts, pajama tops, sweat shirts and the like.

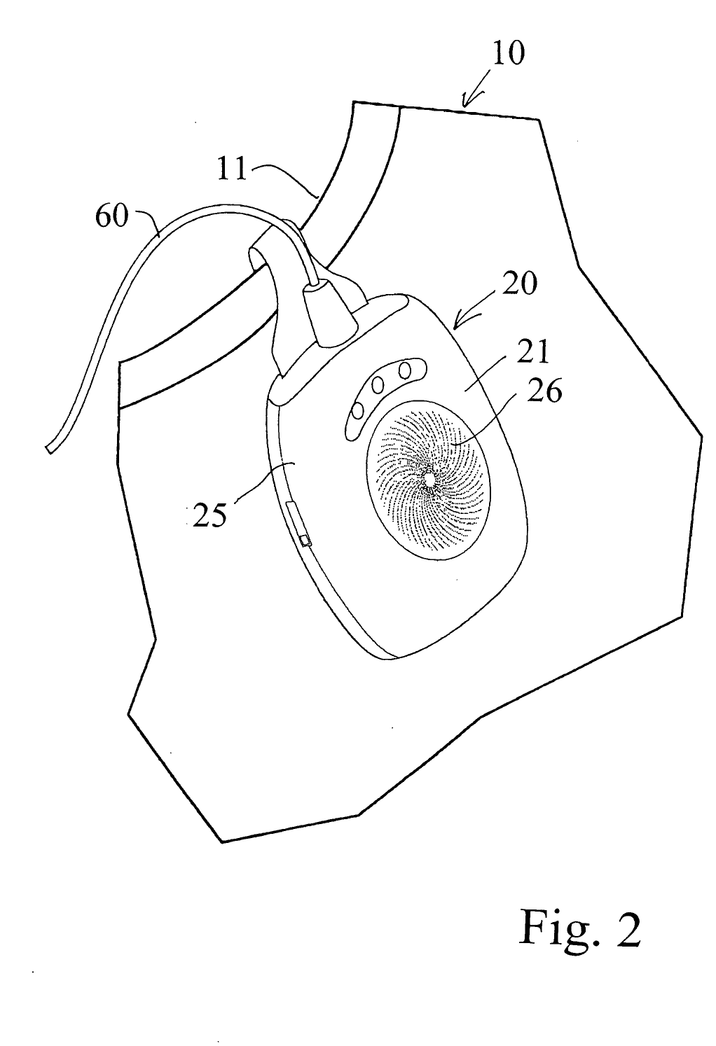

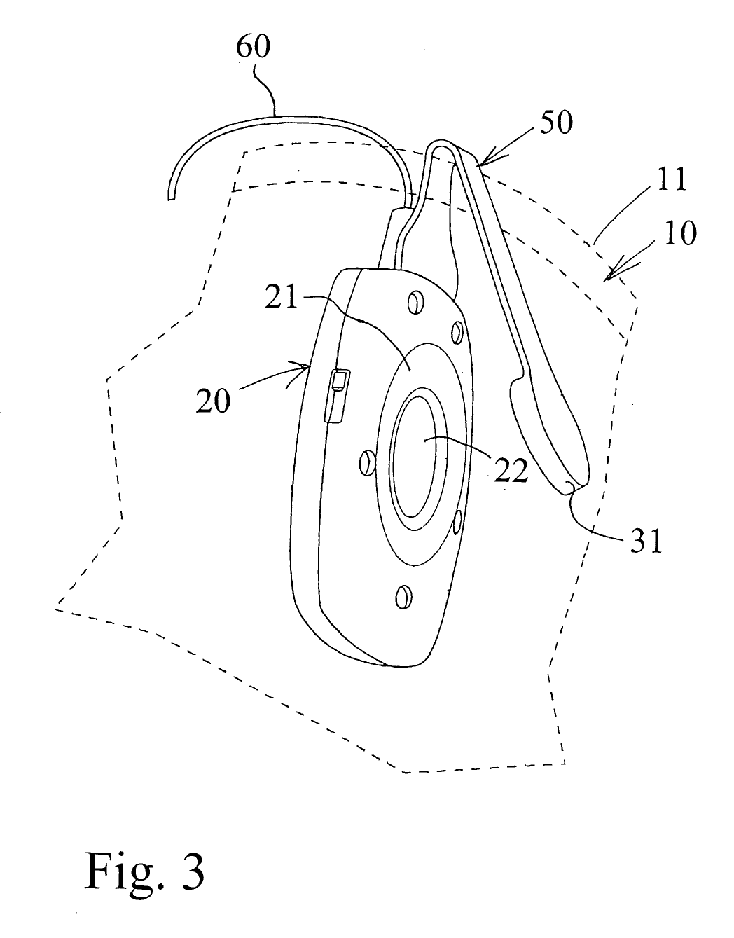

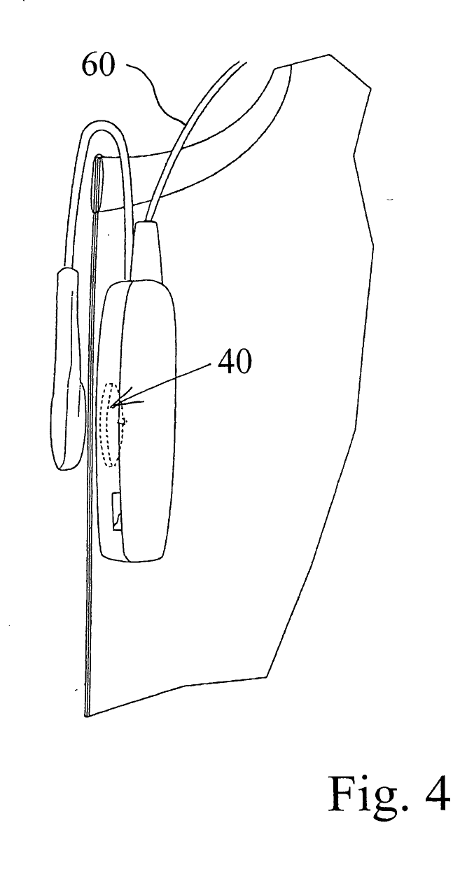

FIG. 2 is a front elevational view of the magnetic fastener 20. The device includes a first segment 21 which is a relatively thin and disc-shaped member including a hollowed-out central portion 22 shown best in FIG. 3. As shown in FIG. 3, the hollowed-out central portion 22 is recessed and generally circular. The magnetic fastener 20 includes a second segment 31 shown best in FIG. 3 which is a disc-shaped steel plate. The fastener 20 includes a housing shown as 25 which is attached to the disc forming first segment 21 and carries an alarm (not shown) as known in the prior art which energizes a centrally mounted speaker 26. Housing 25 also carries a magnet 40 shown in phantom in FIG. 4.

Referring to FIG. 3, a bendable semi-rigid band shown generally as 50 extends between first segment 21 and second segment 31 of magnetic fastener 20 and is connected to both first and second segments 21 and 31, respectively. The semi-rigid band 50 is preferably made of a somewhat rigid plastic that is strong enough to keep the second segment or steel disc 31 centered with respect to the hollowed-out recess 22 formed in first segment 21, but flexible enough to be bent by a child.

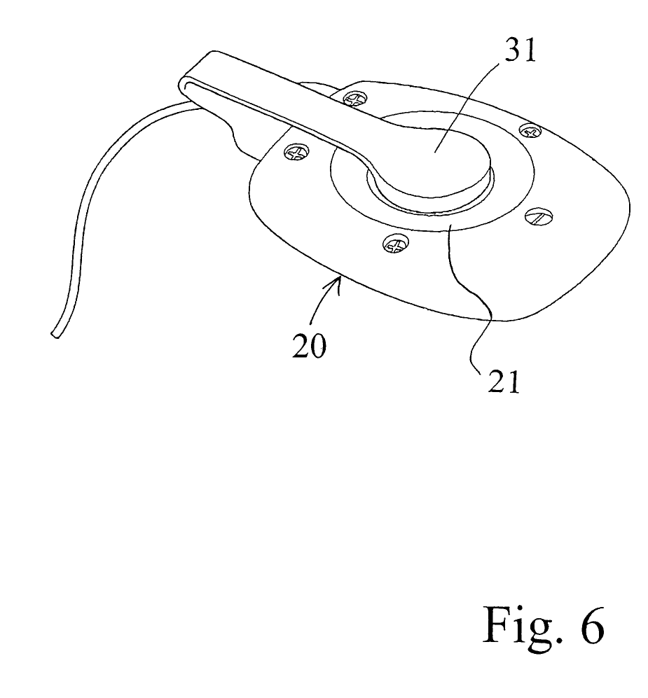

Referring to FIG. 3, the device is illustrated in its partially open position. The device may be easily closed by a child with one hand by simply grasping the first segment 21 with his fingers, placing his thumb on second segment 31 and squeezing them together. In the closed position, illustrated best in FIG. 6, the first and second segments are “magnetically coupled” in the sense that the steel disc that comprises second segment 31 is positioned adjacent the magnet 40 carried by the first segment or disc 21. It is to be understood that the second segment 31 could be fabricated from a magnetic disc and that the first segment 21 simply be a hollowed-out steel disc and not carrying a magnet. Another alternative is that both of the discs 21 and 31 could be magnetic material. In each of these alternatives, the two discs are “magnetically coupled” in the sense that they are capable of maintaining the fastener 20 in position on the undergarment 10.

The preferred placement of the device is over the collar 1 1 of the upper undergarment as illustrated in FIGS. 1-3. Alternately, the invention can be carried by the sleeve opening of the upper undergarment or on the shoulder of the upper undergarment.

In addition to magnetically coupling the discs 21 and 31, the discs can be sized to also accomplish a “physical coupling.” In the preferred embodiment, the second segment 31 is a circular disc which is sized to engage the circular and hollowed-out portion 22 of disc 21 with a snap fit when the undergarment 10 is positioned between the two discs. In the preferred embodiment shown in FIG. 3, the fastener 20 of the present invention is removably attached to the upper undergarment by the magnetic coupling of discs 21 and 31, by the physical coupling of the snap fit accomplished between discs 21 and 31 and additionally by the support offered by band 50 as it folds over the collar 11 of upper undergarment 10.

It is within the scope of the invention to provide the discs 21 and 31 without the connecting band 50 and without the physical coupling or snap fit between the discs 21 and 31. Such a variation of the invention is less preferred in part because the second disc 31 would not be attached to the first disc 21. Furthermore, without band 50 and without the physical coupling, the device could be more easily dislodged from the upper undergarment 10. It is also within the scope of the invention to provide the larger disc inside the upper undergarment, but the preferred design places the larger disc outside the upper undergarment to minimize discomfort to the user.

The preferred material for magnet 40 is a “Rare Earth” material, which most frequently is neodymium, neodymium-iron-boron or Samarium Cobalt (SmCo).

The foregoing description of the invention has been presented for purposes of illustration and description and is not intended to be exhaustive or to limit the invention to the precise form disclosed. Modifications and variations of the above are possible in light of the above teaching. These particular embodiments were chosen and described to best explain the principles of the invention and its practical application, thereby enabling others skilled in the art to best use the invention in various embodiments and with various modifications suited to the particular use contemplated. The scope of the invention is to be defined by the following claims.

1. In an enuresis device wherein a urine sensor is connected to a lower under garment worn by a user to detect the onset of urination, and wherein said urine sensor is electronically connected to an alarm carried by an upper undergarment worn by the user so that the alarm is close to the user's ear, and wherein said alarm sounds at the onset of urination to awaken the user, the improvement comprising:
magnetic fastener and carrier means for carrying said alarm means and for removably attaching said alarm means to said upper undergarment worn by said user, wherein said magnetic fastener and carrier means includes first and second segments, and wherein said first and second segments are positioned on opposite surfaces of said upper undergarment and are adapted to be magnetically coupled to each other.

2. The device of claim 1 further comprising means for physically coupling said first and second segments together.

3. The device of claim 1 further comprising a bendable, semi-rigid band extending between said first and second segments and connected to said first and second segments.

4. The device of claim 1 wherein said first segment comprises a first disc having a hollowed out recess and wherein said second segment comprises a second disc adapted to fit into said hollowed out recess of said first disc.

5. The device of claim 4 wherein said first disc is carried on the outer surface of said undergarment and is sized to be easily grasped by a child and separated from said second disc.

6. The device of claim 4 wherein said first disc carries a magnet and said second disc is made of iron or steel.

7. An enuresis device for use by a child wherein said child wears a lower undergarment covering his or her pubic area and an upper undergarment covering at least a portion of his or her torso, comprising:
a urine sensor, carried by said lower undergarment, to detect the onset of urination,
alarm means electronically connected to said urine sensor, and
magnetic fastener and carrier means for carrying said alarm means and for removably attaching said alarm means to said upper undergarment worn by said user, wherein said magnetic fastener and carrier means includes first and second segments, and wherein said first and second segments are positioned on opposite surfaces of said upper undergarment and are adapted to be magnetically coupled to each other.

8. The device of claim 7 further comprising means for physically coupling said first and second segments together.

9. The device of claim 7 further comprising a bendable, semi-rigid band extending between said first and second segments and connected to said first and second segments.

10. The device of claim 7 wherein said first segment comprises a first disc having a hollowed out recess and wherein said second segment comprises a second disc adapted to fit into said hollowed out recess of said first disc.

11. The device of claim 10 wherein said first disc is carried on the outer surface of said undergarment and is sized to be easily grasped by a child and separated from said second disc.

12. The device of claim 11 wherein said first disc carries a magnet and said second disc is made of iron or steel.
